(19) United States
(12) Patent Application Publication
(10) Pub. No.: US 2023/0394728 A1
(43) Pub. Date: Dec. 7, 2023

(54) Data Sticker Generation for Sports

(71) Applicant: STATS LLC, Chicago, IL (US)

(72) Inventors: Kevin Allinson, Yarm (GB); Anthony Borsumato, Cambridge (GB); Matthew Chamberlain, Guisborough (GB); Jimmy Coverdale, Limerick (IE); Andrew Skweres, Highland Park, IL (US); Patrick Joseph Lucey, Chicago, IL (US)

(73) Assignee: STATS LLC, Chicago, IL (US)

(21) Appl. No.: 18/327,479

(22) Filed: Jun. 1, 2023

Related U.S. Application Data
(60) Provisional application No. 63/365,682, filed on Jun. 1, 2022.

(51) Int. Cl. G06T 11/60; G06V 20/40; G10L 15/22

(52) U.S. Cl. CPC G06T 11/60; G06V 20/42; G10L 15/22; G10L 2015/223

(57) ABSTRACT

A computing system receives a prompt to generate a data sticker for a sporting event. The data sticker includes one or more graphical representations of sports analytics data. The computing system parses the prompt to identify individual components of the prompt. The computing system generates, using a generative artificial intelligence model, the one or more graphical representations based on the individual components of the prompt. The computing system generates an image file comprising the data sticker.

### CROSS-REFERENCE TO RELATED APPLICATIONS

This application claims priority to U.S. Provisional Application Ser. No. 63/365,682, filed Jun. 1, 2022, which is hereby incorporated by reference in its entirety.

### FIELD OF THE DISCLOSURE

The present disclosure generally relates to a mobile application and, more specifically, to a mobile application configured to generate a data sticker corresponding to content provided by a sports data provider.

### BACKGROUND

In professional sports, commentators and platform providers continue to compete in delivering event information and insights to end users. Often, such process is driven by human operators that try to ingest the vast amount of information during the course of a game to deliver insights or information about the game to end users.

### SUMMARY

In some embodiments, a method is disclosed herein. A computing system receives a prompt to generate a data sticker for a sporting event. The data sticker includes one or more graphical representations of sports analytics data. The computing system parses the prompt to identify individual components of the prompt. The computing system generates, using a generative artificial intelligence model, the one or more graphical representations based on the individual components of the prompt. The computing system generates an image file comprising the data sticker.

In some embodiments, a non-transitory computer readable medium is disclosed herein. The non-transitory computer readable medium includes one or more sequences of instructions, which, when executed by a processor, causes a computing system to perform operations. The operations include receiving, by the computing system, a prompt to generate a data sticker for a sporting event. The data sticker includes one or more graphical representations of sports analytics data. The operations further include parsing, by the computing system, the prompt to identify individual components of the prompt. The operations further include generating, by the computing system using a generative artificial intelligence model, the one or more graphical representations based on the individual components of the prompt. The operations further include generating, by the computing system, an image file comprising the data sticker.

In some embodiments, a system is disclosed herein. The system includes a processor and a memory. The memory has programming instructions stored thereon, which, when executed by the processor, causes the system to perform operations. The operations include receiving a prompt to generate a data sticker for a sporting event. The data sticker includes one or more graphical representations of sports analytics data. The operations further include parsing the prompt to identify individual components of the prompt. The operations further include generating, using a generative artificial intelligence model, the one or more graphical representations based on the individual components of the prompt. The operations further include generating an image file comprising the data sticker.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2A illustrates an exemplary graphical user interface, according to example embodiments.

FIG. 2B illustrates an exemplary graphical user interface, according to example embodiments.

FIG. 2C illustrates an exemplary graphical user interface, according to example embodiments.

FIG. 2D illustrates an exemplary graphical user interface, according to example embodiments.

FIG. 2E illustrates an exemplary graphical user interface, according to example embodiments.

FIG. 2F illustrates an exemplary graphical user interface, according to example embodiments.

FIG. 2G illustrates an exemplary graphical user interface, according to example embodiments.

FIG. 2H illustrates an exemplary graphical user interface, according to example embodiments.

FIG. 2I illustrates an exemplary graphical user interface, according to example embodiments.

FIG. 2J illustrates an exemplary graphical user interface, according to example embodiments.

FIG. 2K illustrates an exemplary graphical user interface, according to example embodiments.

FIG. 2L illustrates an exemplary graphical user interface, according to example embodiments.

FIG. 3 is a flow diagram illustrating a method of generating a data sticker, according to example embodiments.

FIG. 4A is a block diagram illustrating data sticker system, according to example embodiments.

FIG. 4B is a block diagram illustrating data sticker system, according to example embodiments.

FIG. 5 is a flow diagram illustrating a method of generating a data sticker, according to example embodiments.

FIG. 6A is a block diagram illustrating a computing device, according to example embodiments.

FIG. 6B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques described herein are generally related to a system and method for generating data stickers for sports. In some embodiments, a data sticker may broadly refer to a graphical representation of content generated by a sports data system, such as Opta®, AutoSTATS, ESPN, and the like. In some embodiments, the data sticker may include various game projections or information about a current game, upcoming game, or historical game. Accordingly, in this manner, such data stickers may be dynamically generated and updated for retrieval by end users. Once generated, end users can download or share their data stickers via various social media applications.

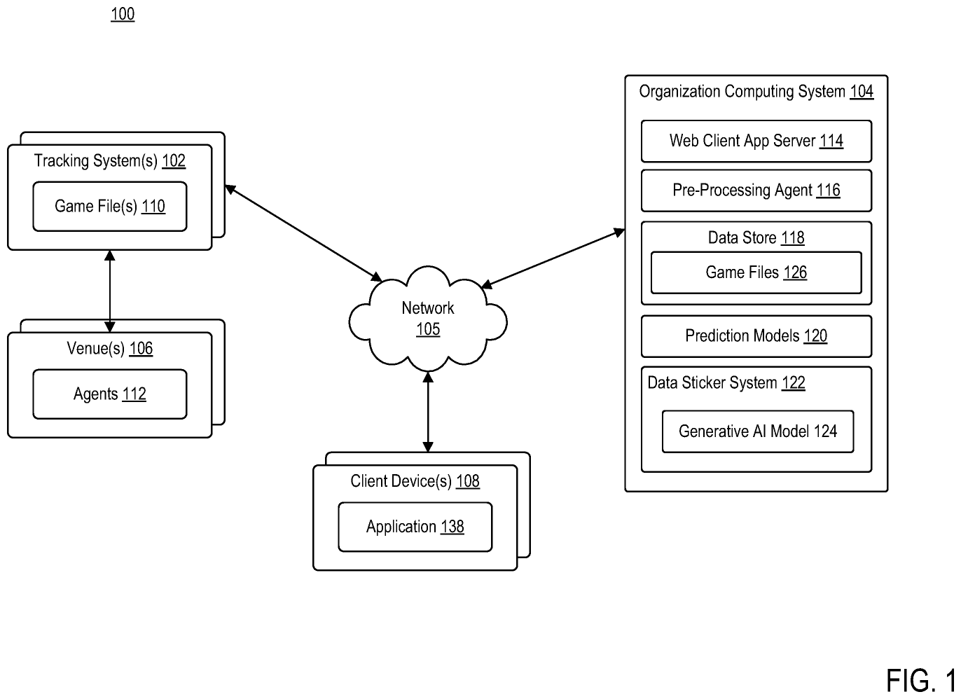

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to record the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In some embodiments, tracking system 102 may be a radio-based system using, for example, radio frequency identification (RFID) tags worn by players or embedded in objects to be tracked. Generally, tracking system 102 may be configured to sample and record, at a high frame rate (e.g., 25 Hz). Tracking system 102 may be configured to store at least player identity and positional information (e.g., (x, y) position) for all agents and objects on the playing surface for each frame in a game file 110.

Game file 110 may be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102. Organization computing system 104 may include at least a web client application server 114, a pre-processing agent 116, a data store 118, one or more prediction models 120, and a data sticker system 122. Each of pre-processing agent 116, one or more prediction models 120, and data sticker system 122 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 126. Each game file 126 may include spatial event data and non-spatial event data. For example, spatial event data may correspond to raw data captured from a particular game or event by tracking system 102. Non-spatial event data may correspond to one or more variables describing the events occurring in a particular match without associated spatial information. For example, non-spatial event data may correspond to each play-by-play event in a particular match. In some embodiments, non-spatial event data may be derived from spatial event data. For example, pre-processing agent 116 may be configured to parse the spatial event data to derive play-by-play information. In some embodiments, non-spatial event data may be derived independently from spatial event data. For example, an administrator or entity associated with organization computing system may analyze each match to generate such non-spatial event data. As such, for purposes of this application, event data may correspond to spatial event data and non-spatial event data.

In some embodiments, each game file 126 may further include the home and away team box scores. For example, the home and away teams' box scores may include the number of team assists, fouls, rebounds (e.g., offensive, defensive, total), steals, and turnovers at each time, t, during gameplay. In some embodiments, each game file 126 may further include a player box score. For example, the player box score may include the number of player assists, fouls, rebounds, shot attempts, points, free-throw attempts, free-throws made, blocks, turnovers, minutes played, plus/minus metric, game started, and the like. Although the above metrics are discussed with respect to basketball, those skilled in the art readily understand that the specific metrics may change based on sport. For example, in soccer, the home and away teams' box scores may include shot attempts, assists, crosses, shots, and the like.

Pre-processing agent 116 may be configured to process data retrieved from data store 118. For example, pre-processing agent 116 may be configured to generate one or more sets of information that may be used to train one or more prediction models 120.

Prediction models 120 may be representative of one or more prediction models utilized by an entity associated with organization computing system 104. For example, prediction models 120 may be representative of one or more prediction models and/or software tools currently available from STATS® Perform, headquartered in Chicago, Illinois. In some embodiments, prediction models 120 may be representative of one or more prediction models associated with AutoSTATS artificial intelligence platform, commercially available from STATS® Perform. In some embodiments, prediction models 120 may be representative of one or more prediction models.

In some embodiments, prediction models 120 may include prediction engines configured to accurately model defensive behavior and its effect on attacking behavior, such as that disclosed in U.S. application Ser. No. 17/649,970, which is hereby incorporated by reference in its entirety.

In some embodiments, prediction models 120 may include prediction models configured to accurately model or classify a team's playing style or a player's playing style, such as that disclosed in U.S. application Ser. No. 16/870,170, which is hereby incorporated by reference in its entirety.

In some embodiments, prediction models 120 may include prediction models configured to accurately model a team's offensive or defensive alignment, such as that disclosed in U.S. application Ser. No. 16/254,128, which is hereby incorporated by reference in its entirety.

In some embodiments, prediction models 120 may include prediction models configured to accurately model a team's formation, such as that disclosed in U.S. application Ser. No. 17/303,361, which is hereby incorporated by reference in its entirety.

In some embodiments, prediction models 120 may include prediction models configured to generate macro predictions and/or micro predictions in sports, such as that disclosed in U.S. application Ser. No. 17/651,960, which is hereby incorporated by reference in its entirety.

In some embodiments, prediction models 120 may include prediction models configured to accurately predict an outcome of an event or game, such as that disclosed in U.S. application Ser. No. 16/254,108, which is hereby incorporated by reference in its entirety.

In some embodiments, prediction models 120 may include prediction models configured to accurately predict an outcome of an event or game, such as that disclosed in U.S. application Ser. No. 16/254,088, which is hereby incorporated by reference in its entirety.

In some embodiments, prediction models 120 may include prediction models configured to accurately generate in-game insights, such as that disclosed in U.S. application Ser. No. 17/653,394, which is hereby incorporated by reference in its entirety.

More generally, in some embodiments, prediction models 120 may be used to generate one or more AI metrics, based on the event data.

Using the one or more AI metrics, prediction models 120 may be configured to generate a plurality of insights about the game. An exemplary insight may include a statement that a player or team is over/under-performing relative to a career/season/tournament, and the like. Another exemplary insight may include a statement that identifies team level streaks (e.g., points, turnovers, rebounds, blocks, first downs, hits, doubles, goals, assists, etc.) and player-level streaks (e.g., points, turnovers, steals, assists, rebounds (offensive/defensive), catches, sacks, hits, etc.).

Data sticker system 122 may be configured to generate one or more data stickers based on the one or more insights generated by prediction models 120 and/or one or more game data received and/or maintained by organization computing system 104. A data sticker may refer to a graphical representation of content that may be generated by prediction models 120 (or another sports data provider). Exemplary data stickers may include, but are not limited to, graphical representations of a scoring play, a heat map representing player movement, a final score, a box score, a live score, and the like. In some embodiments, data sticker system 122 may be configured to index the generated stickers for easy retrieval. For example, data sticker system 122 may dynamically generate and store data stickers based on game, team, league, season, sport, and the like.

In some embodiments, the data stickers may be in a format that application 138 can interpret, such as, but not limited, to an image format, scalable vector graphics (SVG), or hypertext markup language (HTML).

In some embodiments, data sticker system 122 may include a generative artificial intelligent (AI) model 124. Generative AI model 124 may facilitate the data sticker generation process with minimal or reduced interactivity with the end user. For example, rather than provide an interface for a user to build a data sticker utilizing the one or more insights generated by prediction models 120 and/or one or more game data received and/or maintained by organization computing system 104, generative AI model 124 may be trained to automatically generate a data sticker based on a prompt from the end user. In some embodiments, the prompt may be text based (e.g., the user entering a text prompt to an interface in communication with generative AI model 124). In some embodiments, the prompt may be voice based (e.g., talk to text functionality that generates a text prompt based on received audio from the end user).

In some embodiments, generative AI model 124 may be used to modify a generated data sticker. For example, generative AI model 124 may be trained to suggest changes or edits to a manually generated data sticker using data sticker system 122. Such functionality may result in suggested changes to the current data sticker or suggested alternative designs to the existing data sticker. In some embodiments, generative AI model 124 may be used to autocomplete a partially generated data sticker.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 138. Application 138 may be representative of a web browser that allows access to a website or a stand-alone application through which a user may access functionality of organization computing system 104. For example, using application 138, a user of client device 108 may generate a data sticker based on insights generated by prediction models 120.

Within application 138, a data sticker may be represented as a web view that can be manipulated by a user in scale, orientation, and style. Application 138 may not know the inner contents of the web view; instead, application 138 may only know that the web view has a container in a certain position on the canvas the user is currently working on. Each data sticker may be used and manipulated by an end user. For example, an end user may be able to select a data sticker, manipulate the appearance of the data sticker, and/or share the data sticker through, for example, one or more social media sites.

When a user accesses application 138 to retrieve or customize a data sticker, application 138 may request a list of data stickers that are available from organization computing system 104. For example, application 138 may call an API to receive a list of data stickers that may be available to the current user.

Depending on the type of sticker, a user may complete a series of selections to choose the data used in the data sticker. For example, a user may navigate through one or more of a type of sticker, a game, a team, a scoring drive, a league, a season, and the like to identify a relevant data sticker. Once application 138 retrieves a selected data sticker from organization computing system 104, a user may manipulate an appearance of the data sticker by injecting properties into a file or document corresponding to the data sticker. For example, a user may be allowed to inject style properties into the data sticker, such as for default color selection, background color, font styling, and the like.

In some embodiments, the layout of a data sticker can be implemented in a number of ways. For example, application 138 may use cascading sheet styles (CSS), SVG, or HTML for the data sticker layout.

In some embodiments, to render the data sticker, application 138 may inject all of the required data into the file or document corresponding to the data sticker. Such data can then be used by JavaScript to complete the appearance of the data sticker. Such approach may be beneficial for drawing complex illustrations, such as heatmaps or scoring sequences.

In some embodiments, to render the data sticker, application 138 may use handlebar notation within the template. For example, handlebar notation may be used to inject a data object into a markup document using an inline style, i.e., instead of putting a team's name into the template, an insert tag referring to a property in a data object such as {{homeTeam.name}} may be used. Such approach may be beneficial for text-based data stickers.

Once generated, a user can share the graphics containing the data sticker to other users via one or more messages (e.g., email, text message, etc.) or through various social media websites.

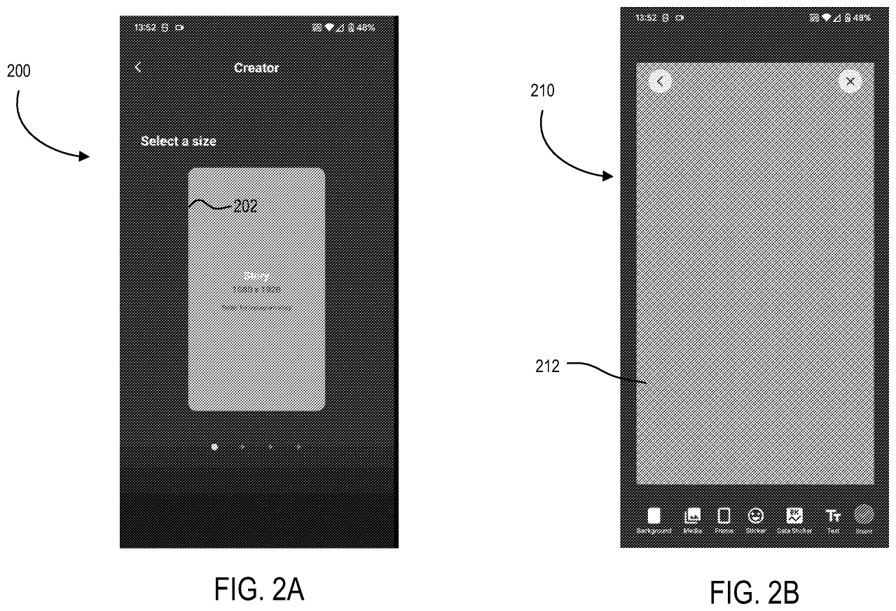

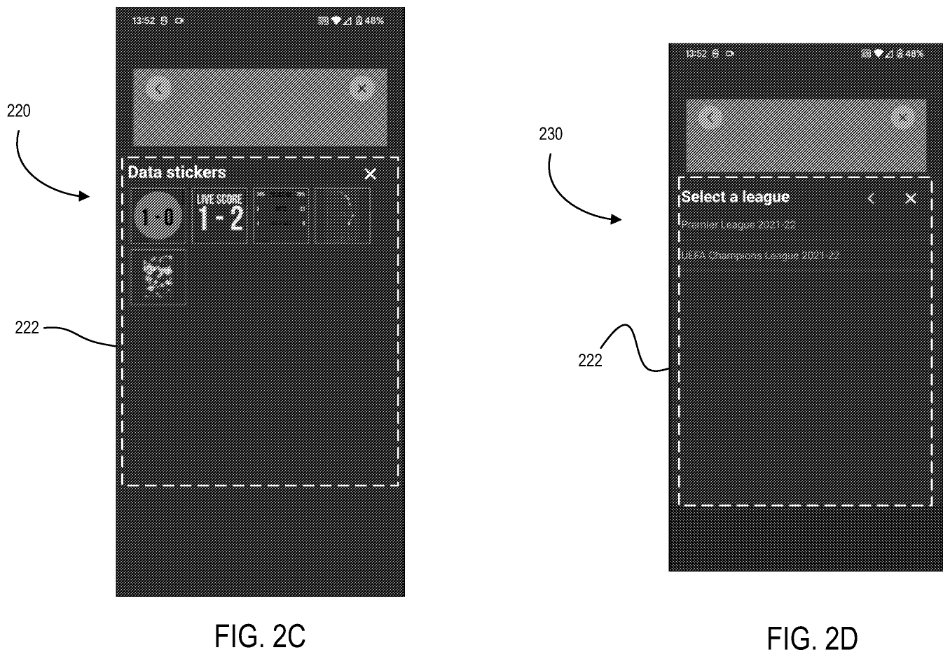

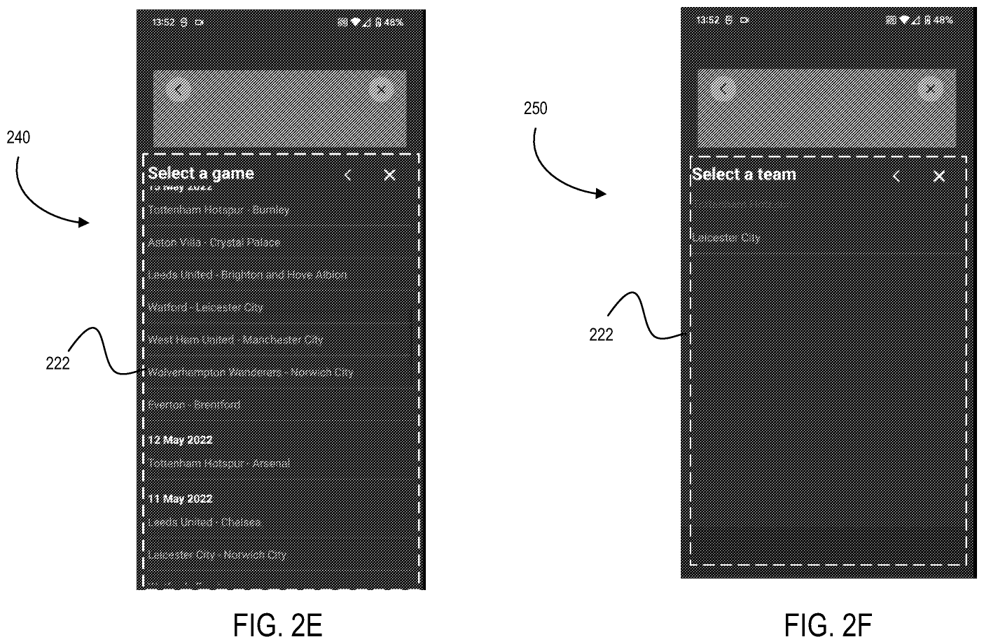

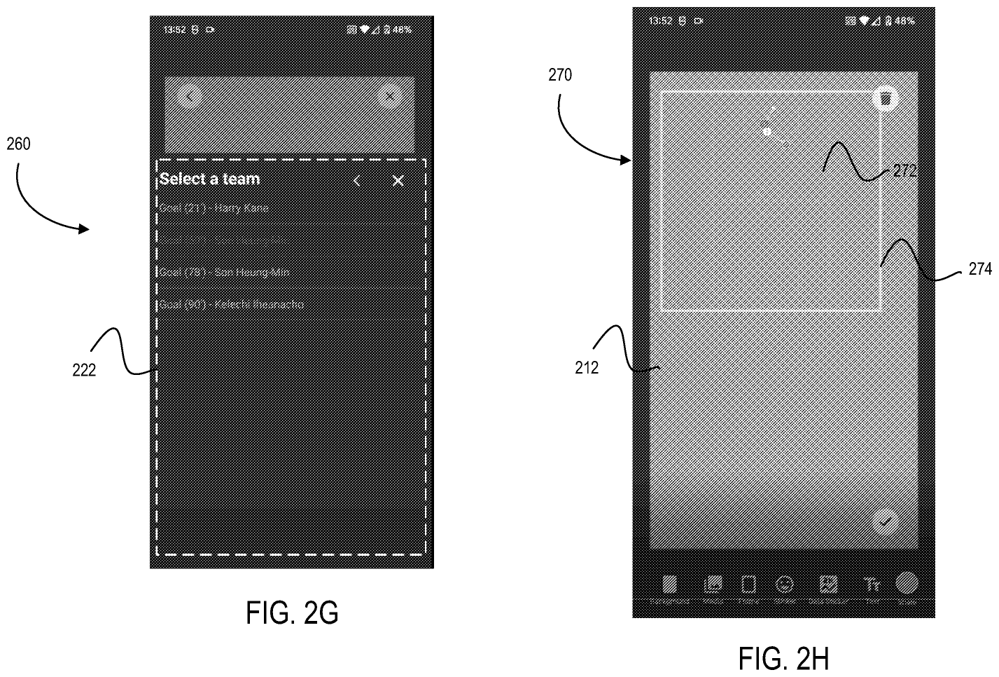

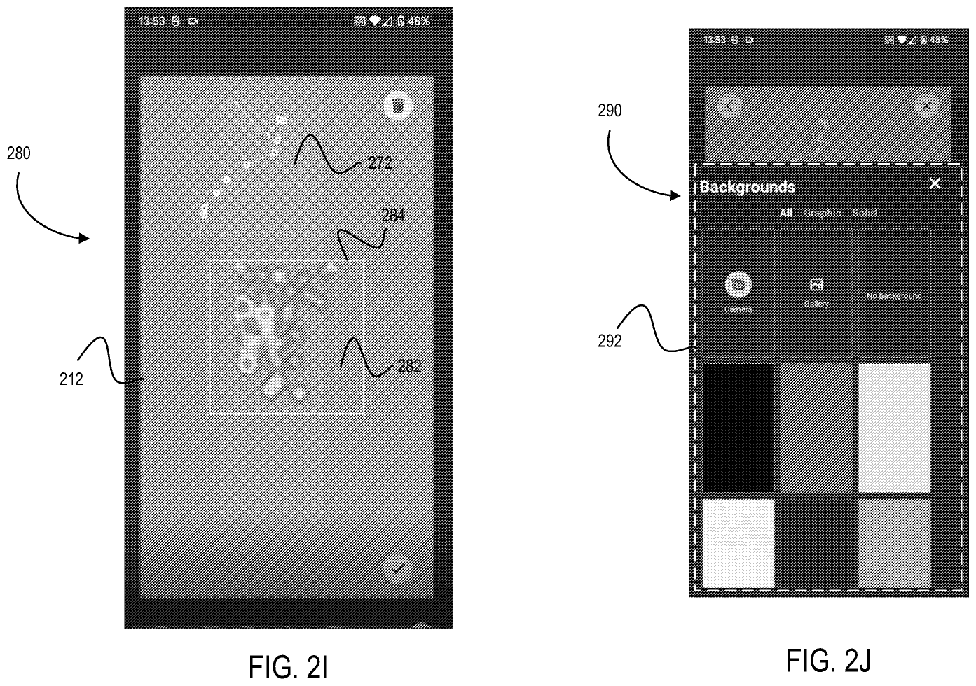

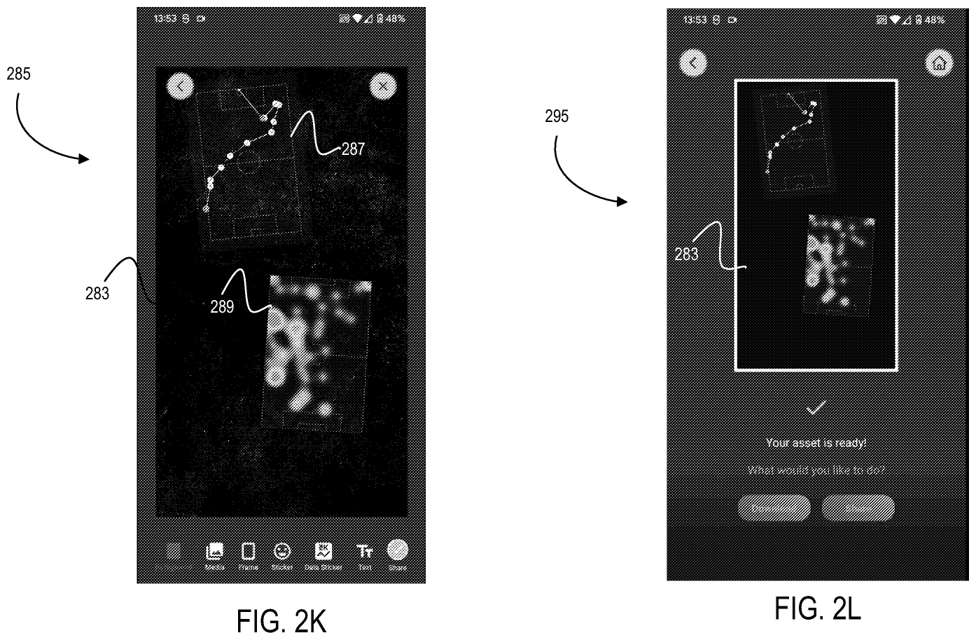

FIG. 2A illustrates an exemplary graphical user interface (GUI) 200, according to example embodiments. GUI 200 may correspond to a graphical user interface associated with application 138. Via GUI 200, a user may generate a data sticker to be downloaded or shared.

As shown, GUI 200 may include a graphical element 202. Graphical element 202 may allow a user to define the aspect ratio of their data sticker.

FIG. 2B illustrates an exemplary graphical user interface (GUI) 210, according to example embodiments. GUI 210 may correspond to a graphical user interface associated with application 138. For example, GUI 210 may be presented to the user after the user selected an aspect ratio for their data sticker. As shown, GUI 210 may include a canvas 212. Via canvas 212, a user may be able to build or customize their data sticker.

FIG. 2C illustrates an exemplary graphical user interface (GUI) 220, according to example embodiments. GUI 220 may correspond to a graphical user interface associated with application 138. As shown, GUI 220 may display a data sticker toolbar 222. In some embodiments, data sticker toolbar 222 may overlay canvas 212. Data sticker toolbar 222 may allow the user to select the type of data sticker they would like to generate. For example, as shown, the user can select a final score data sticker type, a live score data sticker type, a box score data sticker type, a scoring play data sticker type, or a heat map data sticker type.

FIG. 2D illustrates an exemplary graphical user interface (GUI) 230, according to example embodiments. GUI 230 may correspond to a graphical user interface associated with application 138. As shown, GUI 230 may similarly display data sticker toolbar 222. Once the user has selected a type of sticker, application 138 may prompt the user to identify what particular sticker they are looking for. For example, data sticker toolbar 222 may update to prompt the user to select a league. By selecting a league, the user may be provided with all available data stickers corresponding to that league.

FIG. 2E illustrates an exemplary graphical user interface (GUI) 240, according to example embodiments. GUI 240 may correspond to a graphical user interface associated with application 138. As shown, GUI 240 may similarly display data sticker toolbar 222. Once the user has selected a league, application 138 may prompt the user to select a game from that league. As shown, the games may be organized by date. By selecting a game, the user may be provided with all available data stickers corresponding to that game.

FIG. 2F illustrates an exemplary graphical user interface (GUI) 250, according to example embodiments. GUI 250 may correspond to a graphical user interface associated with application 138. As shown, GUI 250 may similarly display data sticker toolbar 222. Once the user has selected a game, application 138 may prompt the user to select one of the teams involved in the game. By selecting a team, the user may be provided with all available data stickers corresponding to that team.

FIG. 2G illustrates an exemplary graphical user interface (GUI) 260, according to example embodiments. GUI 260 may correspond to a graphical user interface associated with application 138. As shown, GUI 260 may similarly display data sticker toolbar 222. Once the user has selected a team, application 138 may prompt the user to select a scoring play. By selecting a scoring play, the user may be provided with all available data stickers corresponding to that scoring play.

FIG. 2H illustrates an exemplary graphical user interface (GUI) 270, according to example embodiments. GUI 270 may correspond to a graphical user interface associated with application 138. As shown, GUI 270 may similarly display a data sticker skeleton 272 in canvas 212. A user can manipulate data sticker skeleton via canvas 212. For example, the user can modify a size or relative positioning of data sticker skeleton 272 via canvas 212. To assist the user with modifying a size or relative positioning of data sticker skeleton 272, a bounding box 274 may overlay or surround data sticker skeleton 272.

FIG. 2I illustrates an exemplary graphical user interface (GUI) 280, according to example embodiments. GUI 280 may correspond to a graphical user interface associated with application 138. As shown, GUI 280 may similarly display a second data sticker skeleton 282 with data sticker skeleton 272 in canvas 212. For example, the user may repeat the steps described above in conjunction with FIGS. 2C-2H to add second data sticker skeleton 282 to canvas 212. To assist the user with modifying a size or relative positioning of second data sticker skeleton 282, a bounding box 284 may overlay or surround second data sticker skeleton 282.

FIG. 2J illustrates an exemplary graphical user interface (GUI) 290, according to example embodiments. GUI 290 may correspond to a graphical user interface associated with application 138. As shown, GUI 290 may display background toolbar 292. Via background toolbar 292, a user may customize the background for their data stickers. As shown, the user may select a default background, no background, a photo from their stored photos as a background, or they may dynamically capture a photo or video for use in the background.

FIG. 2K illustrates an exemplary graphical user interface (GUI) 285, according to example embodiments. GUI 285 may correspond to a graphical user interface associated with application 138. As shown, GUI 285 illustrate data sticker 287 and data sticker 289 with the selected background. Data sticker 287 may correspond to data sticker skeleton 272; data sticker 289 may correspond to data sticker skeleton 282. Application 138 may render data sticker 287 and data sticker 289 with the selected background. Data sticker 287 and data sticker 289 may collective form data sticker 283.

FIG. 2L illustrates an exemplary graphical user interface (GUI) 295, according to example embodiments. GUI 295 may correspond to a graphical user interface associated with application 138. As shown, GUI 295 illustrate completed data sticker 283. Via GUI 295, a user may download or share data sticker 283. For example, the user may download data sticker 283 to their local files or share data sticker 283 to external users or through various social media websites.

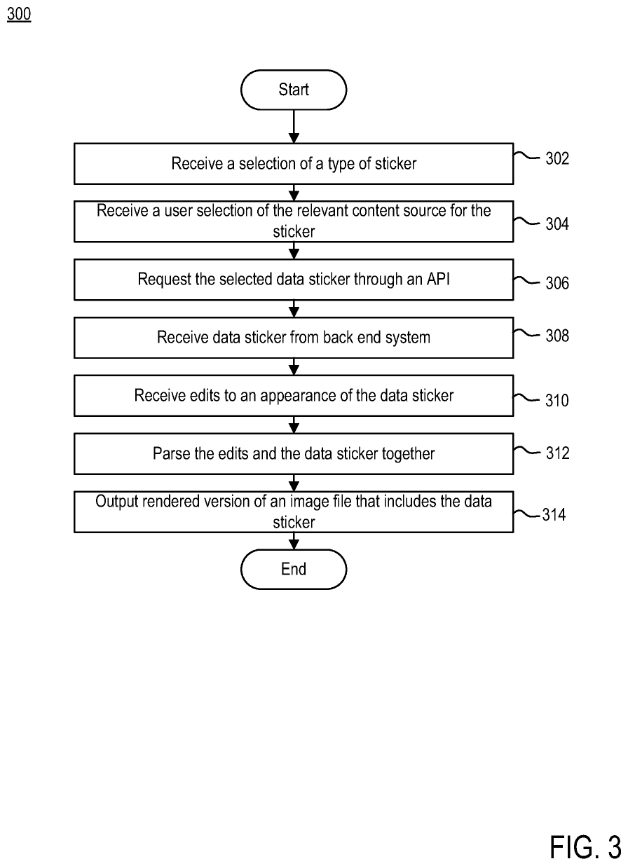

FIG. 3 is a flow diagram illustrating a method 300 of generating a data sticker, according to example embodiments. Method 300 may begin at step 302.

At step 302, client device 108 may receive a selection of a type of data sticker. For example, a user may launch application 138 to select a type of data sticker to generate. In some embodiments, the types of data stickers may include, but are not limited to, a final score data sticker type, a live score data sticker type, a box score data sticker type, a scoring play data sticker type, or a heat map data sticker type.

At step 304, client device 108 may receive a selection of a relevant content source for the data sticker. For example, each sticker type may cause the user to be prompted with additional fields for narrowing down a relevant sticker for the user. Exemplary additional fields may include, but are not limited to, league, game, team, player, event, and the like. The combination of selections may assist application 138 in requesting a correct data sticker from organization computing system 104.

At step 306, client device 108 may request the selected data sticker through an application programming interface (API). For example, application 138 may interface with data sticker system 122 via an API to request a data sticker based on the constraints defined by the user. For example, based on the type of sticker and the additional fields requested by the user, data sticker system 122 may submit a request to data sticker system 122 to retrieve the identified data sticker.

At step 308, client device 108 may receive the data sticker from organization computing system 104. For example, based on the request from application 138, application 138 may receive the requested sticker through the API for display to the user.

At step 310, client device 108 may receive customizations to an appearance of the data sticker. In some embodiments, the customizations may include a sizing of the data sticker. In some embodiments, the customizations may include a positioning of the data sticker. In some embodiments, the customizations may include a background color for the data sticker.

At step 312, client device 108 may parse the customizations and the data sticker together. For example, application 138 may generate an image file or scalable markup file that includes the data sticker with information associated with the requested customizations.

At step 314, client device 108 may output a rendered version of the image file. For example, application 138 may render the data stickers in the image file in accordance with the requested customizations.

As indicated above, although not presently shown in FIG. 3, in some embodiments, generative AI model 124 may be used to modify a generated data sticker or image file. For example, generative AI model 124 may suggest changes or edits to the generated data sticker or image file. Such functionality may result in suggested changes to the current data sticker or suggested alternative designs to the existing data sticker.

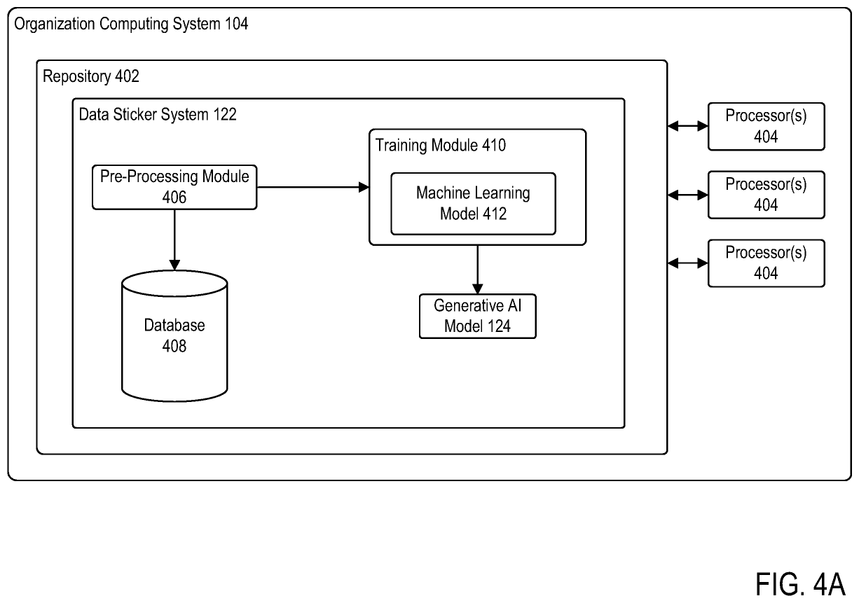

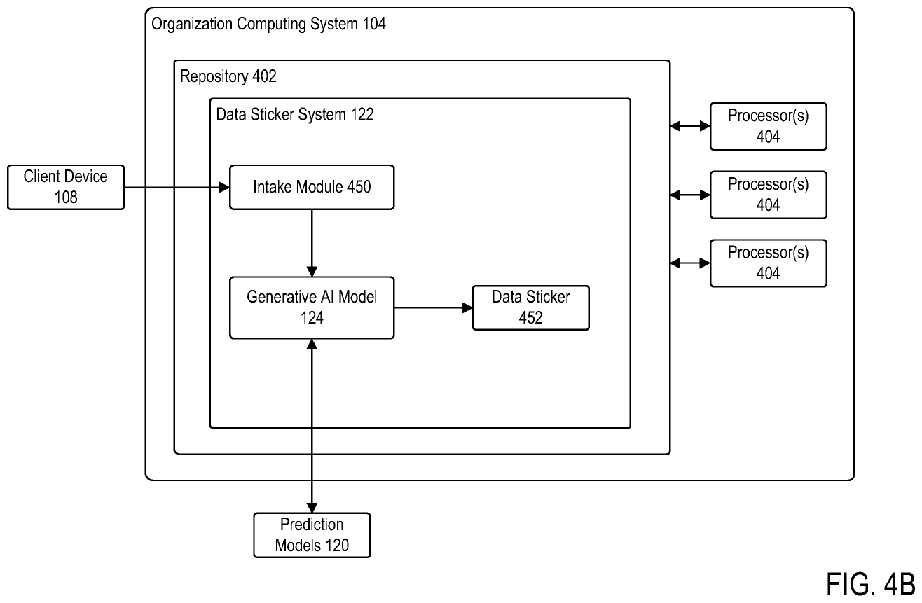

FIG. 4A is a block diagram illustrating organization computing system 104, according to example embodiments. As shown, organization computing system 104 may include repository 402 and one or more computer processors 404.

Repository 402 may be representative of any type of storage unit and/or device (e.g., a file system, database, collection of tables, or any other storage mechanism) for storing data. Further, repository 402 may include multiple different storage units and/or devices. The multiple different storage units and/or devices may or may not be of the same type or located at the same physical site. As shown, repository 402 may include at least data sticker system 122.

As shown, data sticker system 122 may include pre-processing module 406, database 408, training module 410, and generative AI model 124. Each of pre-processing module 406 and training module 410 may be comprised of one or more software modules. The one or more software modules are collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Pre-processing module 406 may be configured to generate training data sets from data stored in database 408. For example, database 408 may include a plurality of prompt/sticker pairs. Each prompt/sticker pair may include a text based prompt and a sticker that should be generated based on the text based prompt. An exemplary text based prompt may be: Generate a data sticker for today's Knicks Sixers game that includes a graphic of Jalen Brunson and his box score. An exemplary sticker corresponding to the prompt may include a graphic of Jalen Brunson, a graphic of Jalen Brunson's box score, an indication of today's date, and an indication that the game was against the Sixers. Pre-processing module 406 may gather a plurality of these prompt/sticker pairs to generate a training data set for training module 410.

Training module 410 may be configured to train machine learning model 412 to generate a data sticker based on a prompt received by an end user based on the training data sets. In some embodiments, machine learning model 412 may be representative of a transformer network. During training, machine learning model 412 may learn which images correspond to which portions of a prompt based on the training data sets.

In some embodiments, training machine learning model 412 may involve training module 410 training machine learning model 412 to submit an API call to one or more prediction models 120 in order to obtain analytics data for inclusion in a data sticker. Continuing with the above example, training module 410 may train machine learning model 412 to submit an API call to one or more prediction models 120 in order to obtain Jalen Brunson's box score or a graphic that includes Jalen Brunson's box score. In this manner, training module 410 may train machine learning model 412 to submit API calls depending on the context of the user's prompt.

Once training is complete, a trained machine learning model (i.e., “generative AI model 124”) may be deployed.

FIG. 4B is a block diagram illustrating organization computing system 104, according to example embodiments. FIG. 4B may represent a deployment computing environment for generative AI model 124 following training.

As shown, intake module 450 may receive a prompt from a user. In some embodiments, the prompt may be a text based prompts. In some embodiments, the prompt may be a voice based prompts. In those embodiments in which the prompt is a voice based prompt, intake module 450 may be configured to convert the voice based prompt to a text based prompt using one or more voice-to-text algorithms.

Generative AI model 124 may be configured to receive the prompt from intake module 450. Generative AI model 124 may analyze the prompt to identify one or more components in the prompt. Continuing with the above example, generative AI model 124 may identify the following components: Jalen Brunson, box score, today's game, Sixers. Based on these components, generative AI model 124 may be configured to generate a data sticker 452.

In some embodiments, generative AI model 124 may determine that one of the components may require an API call. For example, the request of “box score” may prompt the generative AI model 124 to generate an API call to one or more prediction models 120. Accordingly, generative AI model 124 may generate an API call that requests Jalen Brunson's box score against the Sixers during the game that took place on Feb. 5, 2023. Generative AI model 124 may utilize the information received from the API call in the generated data sticker 452.

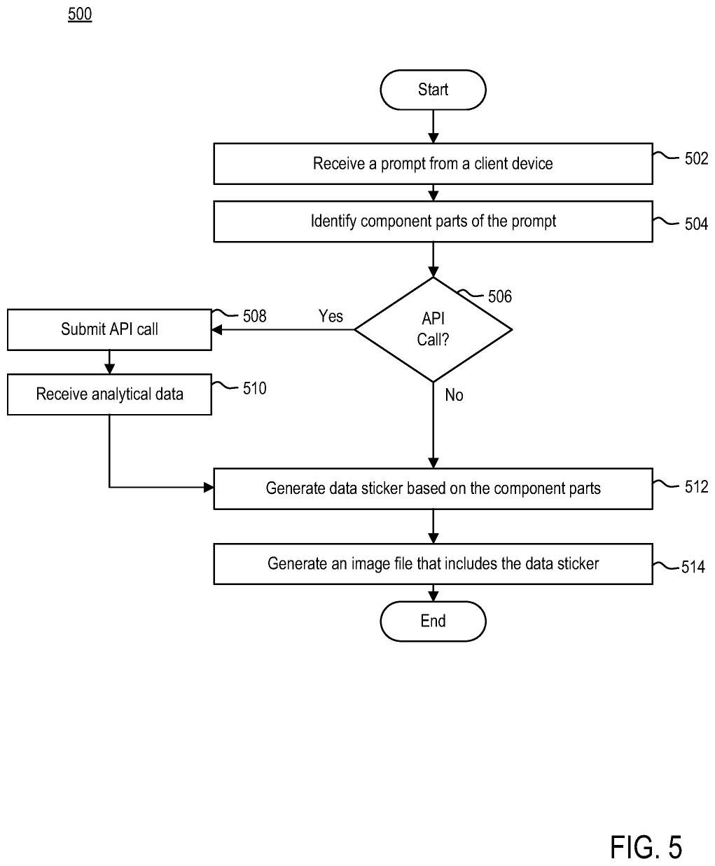

FIG. 5 is a flow diagram illustrating a method 500 of generating a data sticker utilizing a generative AI approach, according to example embodiments. Method 500 may begin at step 502.

At step 502, organization computing system 104 may receive a prompt from client device 108. In some embodiments, organization computing system 104 may receive the prompt from client device 108 via application 138 executing thereon. In some embodiments, the prompt may be a text-based prompt. In some embodiments, the prompt may be a voice-based prompt. If the prompt is a voice-based prompt, data sticker system 122 may convert the voice-based prompt to a text-based prompt using one or more voice-to-text algorithms.

At step 504, organization computing system 104 may identify the component parts of the prompt. For example, data sticker system 122 may analyze the prompt to identify those components that should have a corresponding graphical representation in the data sticker.

At step 506, organization computing system 104 may determine whether an API call is needed to generate any of the components of the data sticker. For example, as indicated above, generative AI model 124 may be trained to identify those components for which an API call may be necessary.

If, at step 506, organization computing system 104 determines that an API call is needed, then method 500 may proceed to step 508. At step 508, organization computing system 104 may generate and submit an API call based on the prompt. In some embodiments, data sticker system 122 may generate an API call based on one of the components in the prompt. Data sticker system 122 may then submit the API call to one or more prediction models 120 associated with organization computing system 104.

At step 510, organization computing system 104 may receive the analytical data corresponding to the API call from one or more prediction models 120. In some embodiments, the analytical data may be in the form of text-based analytical data. In some embodiments, the analytical data may be in the form of a pre-generated graphic that includes the text-based analytical data.

At step 512, organization computing system 104 may generate a data sticker based on the components parts. For example, for each identified component, data sticker system 122 may generate a graphical representation to be included in the data sticker via generative AI model 124. In some embodiments, generating the data sticker may include data sticker system 122 merging the received analytical data from one or more prediction models 120 into the data sticker.

At step 514, organization computing system 104 may generate an image file that includes the data sticker. In some embodiments, data sticker system 122 may deliver the image file to the user via application 138 executing on client device 108.

As those skilled in the art understand, once the image file is generated, end users may have the ability to customize the image file and/or the data sticker generated by data sticker system 122. For example, end users may customize the image file and/or the data sticker using any of the approaches discussed above in conjunction with FIGS. 2A-2L and FIG. 3.

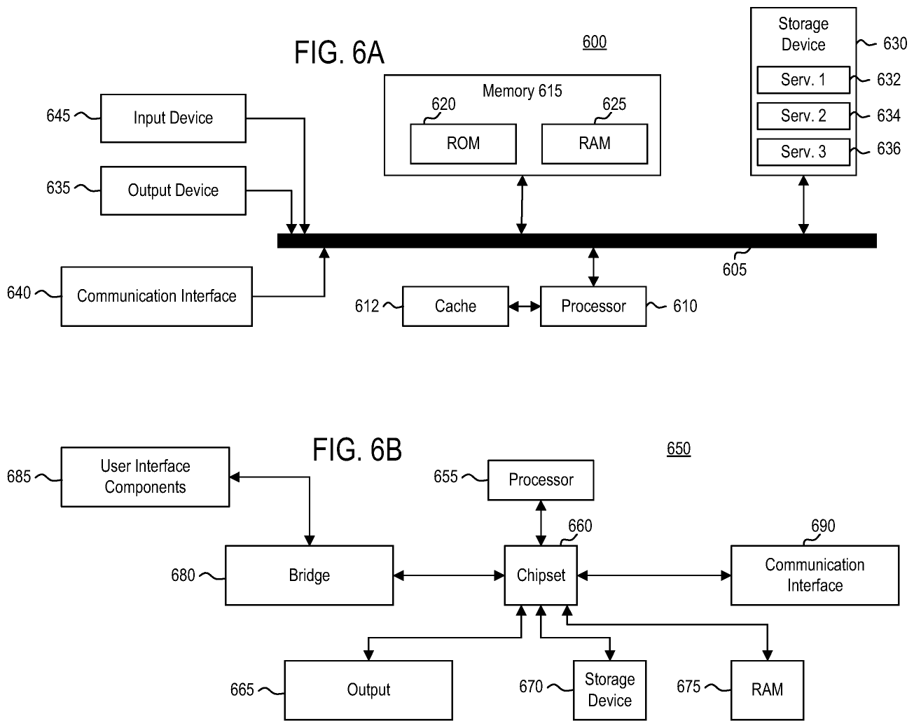

FIG. 6A illustrates a system bus architecture of computing system 600, according to example embodiments. System 600 may be representative of at least a portion of organization computing system 104. One or more components of system 600 may be in electrical communication with each other using a bus 605. System 600 may include a processing unit (CPU or processor) 610 and a system bus 605 that couples various system components including the system memory 615, such as read only memory (ROM) 620 and random access memory (RAM) 625, to processor 610. System 600 may include a cache of high-speed memory connected directly with, in close proximity to, or integrated as part of processor 610. System 600 may copy data from memory 615 and/or storage device 630 to cache 612 for quick access by processor 610. In this way, cache 612 may provide a performance boost that avoids processor 610 delays while waiting for data. These and other modules may control or be configured to control processor 610 to perform various actions. Other system memory 615 may be available for use as well. Memory 615 may include multiple different types of memory with different performance characteristics. Processor 610 may include any general purpose processor and a hardware module or software module, such as service 1 632, service 2 634, and service 3 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system 600, an input device 645 may represent any number of input mechanisms, such as a microphone for speech, a touch-sensitive screen for gesture or graphical input, keyboard, mouse, motion input, speech and so forth. An output device 635 may also be one or more of a number of output mechanisms known to those of skill in the art. In some instances, multimodal systems may enable a user to provide multiple types of input to communicate with computing system 600. Communications interface 640 may generally govern and manage the user input and system output. There is no restriction on operating on any particular hardware arrangement and therefore the basic features here may easily be substituted for improved hardware or firmware arrangements as they are developed.

Storage device 630 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 may include services 632, 634, and 636 for controlling the processor 610. Other hardware or software modules are contemplated. Storage device 630 may be connected to system bus 605. In one aspect, a hardware module that performs a particular function may include the software component stored in a computer-readable medium in connection with the necessary hardware components, such as processor 610, bus 605, output device 635 (e.g., display), and so forth, to carry out the function.

FIG. 6B illustrates a computer system 650 having a chipset architecture that may represent at least a portion of organization computing system 104. Computer system 650 may be an example of computer hardware, software, and firmware that may be used to implement the disclosed technology. System 650 may include a processor 655, representative of any number of physically and/or logically distinct resources capable of executing software, firmware, and hardware configured to perform identified computations. Processor 655 may communicate with a chipset 660 that may control input to and output from processor 655. In this example, chipset 660 outputs information to output 665, such as a display, and may read and write information to storage device 670, which may include magnetic media, and solid state media, for example. Chipset 660 may also read data from and write data to storage device 675 (e.g., RAM). A bridge 680 for interfacing with a variety of user interface components 685 may be provided for interfacing with chipset 660. Such user interface components 685 may include a keyboard, a microphone, touch detection and processing circuitry, a pointing device, such as a mouse, and so on. In general, inputs to system 650 may come from any of a variety of sources, machine generated and/or human generated.

Chipset 660 may also interface with one or more communication interfaces 690 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 655 analyzing data stored in storage device 670 or storage device 675. Further, the machine may receive inputs from a user through user interface components 685 and execute appropriate functions, such as browsing functions by interpreting these inputs using processor 655.

It may be appreciated that example systems 600 and 650 may have more than one processor 610 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method comprising:
receiving, by a computing system, a prompt to generate a data sticker for a sporting event, the data sticker comprising one or more graphical representations of sports analytics data;
parsing, by the computing system, the prompt to identify individual components of the prompt;
generating, by the computing system using a generative artificial intelligence model, the one or more graphical representations based on the individual components of the prompt; and
generating, by the computing system, an image file comprising the data sticker.

2. The method of claim 1, wherein the prompt is received responsive to a partially generated data sticker, wherein the prompt is a request to complete the partially generated data sticker using the generative artificial intelligence model.

3. The method of claim 1, wherein the prompt is a voice-based prompt.

4. The method of claim 3, further comprising:
converting, by the computing system, the voice-based prompt into a text-based prompt.

5. The method of claim 1, further comprising:
determining, by the computing system, that at least one individual component of the individual components requires an application programming interface (API) call to retrieve prediction data generated by one or more prediction models; and
based on the determining, generating, by the computing system, the API call to the one or more prediction models to obtain the prediction data.

6. The method of claim 5, wherein generating, by the computing system using the generative artificial intelligence model, the one or more graphical representations based on the individual components of the prompt comprises:
generating a graphical representation of the prediction data received from the one or more prediction models.

7. The method of claim 5, wherein generating, by the computing system using the generative artificial intelligence model, the one or more graphical representations based on the individual components of the prompt comprises:
merging the prediction data received form the one or more prediction models with the one or more graphical representations to generate the data sticker.

8. A non-transitory computer readable medium comprising one or more sequences of instructions, which, when executed by a processor, causes a computing system to perform operations comprising:
receiving, by the computing system, a prompt to generate a data sticker for a sporting event, the data sticker comprising one or more graphical representations of sports analytics data;
parsing, by the computing system, the prompt to identify individual components of the prompt;
generating, by the computing system using a generative artificial intelligence model, the one or more graphical representations based on the individual components of the prompt; and
generating, by the computing system, an image file comprising the data sticker.

9. The non-transitory computer readable medium of claim 8, wherein the prompt is received responsive to a partially generated data sticker, wherein the prompt is a request to complete the partially generated data sticker using the generative artificial intelligence model.

10. The non-transitory computer readable medium of claim 8, wherein the prompt is a voice-based prompt.

11. The non-transitory computer readable medium of claim 10, further comprising:
converting, by the computing system, the voice-based prompt into a text-based prompt.

12. The non-transitory computer readable medium of claim 8, further comprising:
determining, by the computing system, that at least one individual component of the individual components requires an application programming interface (API) call to retrieve prediction data generated by one or more prediction models; and
based on the determining, generating, by the computing system, the API call to the one or more prediction models to obtain the prediction data.

13. The non-transitory computer readable medium of claim 12, wherein generating, by the computing system using the generative artificial intelligence model, the one or more graphical representations based on the individual components of the prompt comprises:
generating a graphical representation of the prediction data received from the one or more prediction models.

14. The non-transitory computer readable medium of claim 12, wherein generating, by the computing system using the generative artificial intelligence model, the one or more graphical representations based on the individual components of the prompt comprises:
merging the prediction data received form the one or more prediction models with the one or more graphical representations to generate the data sticker.

15. A system comprising:
a processor; and
a memory having programming instructions stored thereon, which, when executed by the processor, causes the system to perform operations comprising:
receiving a prompt to generate a data sticker for a sporting event, the data sticker comprising one or more graphical representations of sports analytics data;
parsing the prompt to identify individual components of the prompt;
generating, using a generative artificial intelligence model, the one or more graphical representations based on the individual components of the prompt; and
generating an image file comprising the data sticker.

16. The system of claim 15, wherein the prompt is a voice-based prompt.

17. The system of claim 16, wherein the operations further comprise:
converting the voice-based prompt into a text-based prompt.

18. The system of claim 15, wherein the operations further comprise:
determining that at least one individual component of the individual components requires an application programming interface (API) call to retrieve prediction data generated by one or more prediction models; and
based on the determining, generating the API call to the one or more prediction models to obtain the prediction data.

19. The system of claim 18, wherein generating, using the generative artificial intelligence model, the one or more graphical representations based on the individual components of the prompt comprises:
generating a graphical representation of the prediction data received from the one or more prediction models.

20. The system of claim 18, wherein generating, using the generative artificial intelligence model, the one or more graphical representations based on the individual components of the prompt comprises:
merging the prediction data received form the one or more prediction models with the one or more graphical representations to generate the data sticker.
